(19) United States
(12) Patent Application Publication
(10) Pub. No.: US 2009/0128120 A1
(43) Pub. Date: May 21, 2009

(54) REFERENCE VOLTAGE GENERATION CIRCUIT, AD CONVERTER, DA CONVERTER, AND IMAGE PROCESSOR

(75) Inventor: Tetsuo TATSUDA, Ina (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/270,165

(22) Filed: Nov. 13, 2008

(30) Foreign Application Priority Data
Nov. 15, 2007 (JP) 2007-296357

(51) Int. Cl. H02M 3/156

(52) U.S. Cl. 323/351

(57) ABSTRACT

A reference voltage generation circuit includes a plurality of resistors that divide a prescribed input reference voltage into a plurality of divisional voltages and a plurality of analogue switches one of which selects one of the divisional voltages to output the selected divisional voltage as a desired reference voltage. Each of the analogue switches is formed of a transistor, and a size of the transistor is varied corresponding to a level of the reference voltage to be output.

### BACKGROUND

1. Technical Field

Several aspects of the present invention relate to a reference voltage generation circuit, an AD converter, a DA converter, and an image processor.

2. Related Art

An AD converter equipped with, for example, a resistor array 7, a first comparator 1 and a second comparator 2 is well known. In the AD converter, the first comparator and the second comparator are alternately arranged with respect to the resistor array 7 as shown in FIG. 6. JP-A-08-330961 is an example of related art.

In the resistor array 7, a plurality of resistors R are connected in series between two terminals applied with a predetermined reference voltage. The first comparator 1 is configured of analogue switches 3a1, 3a2 and 4, a capacitor 5a and an inverter 6a, and compares a voltage of the connection point between the resistors R, R in the resistor array 7 with an analogue voltage AVin to be compared to obtain the difference in level. The second comparator 2 is configured of analogue switches 3b1 to 3b 4 and 4, capacitors 5b1and 5b2 and an inverter 6b, and compares an average voltage of connection point voltages at both end positions of each of the resistors R, R in the resistor array 7 with the analogue voltage to be compared to obtain the difference in level.

As shown in FIG. 6, the AD converter is equipped with a reference voltage generation circuit for generating a reference voltage in order to allow the comparators 1 and 2 to AD-convert the analogue voltage AVin. The reference voltage generation circuit in FIG. 6 is configured of the resistor array having the resistors connected in series and the analogue switches each respectively connected to the position between the resistors in the resistor array. Each of the analogue switches is configured of a transfer gate having an N-channel MOS transistor and a P-channel MOS transistor coupled in parallel.

In a case where an n-bit parallel type AD converter is used as the above AD converter, it requires 2ⁿ resistors connected in series, (2ⁿ−1) analogue switches and (2ⁿ−1) comparators, resulting in problems that the number of circuit components and the area of the circuit are increased. For example, in a case where the transfer gate having the P-type and N-channel MOS transistors coupled in parallel is used as the analogue switch, the size of the switch is increased because of limitation in a manufacturing process of isolating the P-channel and N-channel MOS transistors from each other, and each of both of the MOS transistors requires a control line and a signal line.

That is, in a case where the transfer gate is used as the analogue switch, the problem occurs that the circuit area and the amount of wires of the reference voltage generation circuit are increased.

In order to solve the above problem, only one of the P-channel and N-channel MOS transistors can be used as the analogue switch. However, in a case where only one of the P-channel and N-channel MOS transistors is used and two reference voltages at both ends of the resistor array having the resistors connected in series are near the upper limit in the operable voltage range of the transistor, the reference voltage generation circuit hardly generates the reference voltage corresponding to n bits at a high speed.

### SUMMARY

An advantage of the present invention is to provide a reference voltage generation circuit that can retain the operation speed at which a plurality of analogue switches output desired reference voltages, and can minimize the occupied area of the analogue switches.

Another advantage of the invention is to provide an AD converter and a DA converter each of which can utilize the above described reference voltage generation circuit.

Further, another advantage of the invention is to provide an image processor which can utilize the above described AD converter or DA converter.

A reference voltage generation circuit according to a first aspect of the invention includes a plurality of resistors that divide a prescribed input reference voltage into a plurality of divisional voltages and a plurality of analogue switches one of which selects one of the divisional voltages to output the selected divisional voltage as a desired reference voltage. Each of the analogue switches is formed of a transistor, and a size of the transistor is varied corresponding to a level of reference voltage to be output.

A reference voltage generation circuit according to a second aspect of the invention includes a plurality of resistors that divide a prescribed input reference voltage into a plurality of divisional voltages and a plurality of analogue switches one of which selects one of the divisional voltages to output the selected divisional voltage as a desired reference voltage. Each of the analogue switches is formed of a transistor, each size of each of a prescribed number of transistors is made to be a prescribed value, and sizes of the remaining transistors are varied corresponding to levels of the reference voltages to be output, respectively.

In the reference voltage generation circuit according to the invention, each of the analogue switches may be configured of one of an N-channel MOS transistor, a P-channel MOS transistor, and a transfer gate having a combination of N-type and P-type transistors.

A reference voltage generation circuit according to a third aspect of the invention includes a plurality of resistors that divide a prescribed input reference voltage into a plurality of divisional voltages, and a plurality of analogue switches one of which selects one of the divisional voltages to output the selected divisional voltage as a desired reference voltage. The analogue switches are formed of a prescribed number of N-channel MOS transistors, and a prescribed number of P-channel MOS transistors. The sizes of the prescribed number of N-type and P-type transistors are varied corresponding to levels of the reference voltage to be output, respectively.

An AD converter according to a fourth aspect of the invention includes the reference voltage generation circuit according to the first aspect of the invention. The AD converter performs AD converting by using a desired reference voltage output from the reference voltage generation circuit.

A DA converter according to a fifth aspect of the invention includes the reference voltage generation circuit according to the first aspect of the invention. The DA converter performs DA converting by using a desired reference voltage output from the reference voltage generation circuit.

In an image processor according to a sixth aspect of the invention includes at least one of the AD converter according to the fourth aspect of the invention, and the DA converter according to the fifth aspect of the invention.

According to the reference voltage generation circuit having the above structure, it is possible to minimize the occupied area of the plurality of analogue switches while retaining the operation speed at which the plurality of analogue switches output the desired reference voltages.

According to the AD converter or the DA converter of the invention, it is possible to perform comparatively high speed AD-converting or DA-converting. According to the image forming processor of the invention, it is possible to increase the speed of the processing of an image.

### BRIEF DESCRIPTION OF THE DRAWINGS

The invention will be described with reference to the accompanying drawings, wherein like numbers reference like elements.

FIG. 1 is a circuit diagram showing a structure of a first embodiment of a reference voltage generation circuit of the invention.

FIG. 2 is a graph illustrating a relationship between a performance and an output reference voltage of a transistor of the invention.

FIG. 3 is a graph illustrating one example of a static characteristic of an NMOS transistor.

FIG. 4 is a graph illustrating one example of a static characteristic of an NMOS transistor in which a length of a gate is the same as that in FIG. 3, but the width of the gate is ten times of that in FIG. 3.

FIG. 5 is a circuit diagram showing a structure of a second embodiment of a reference voltage generation circuit of the invention.

FIG. 6 is a circuit diagram showing an example of related arts.

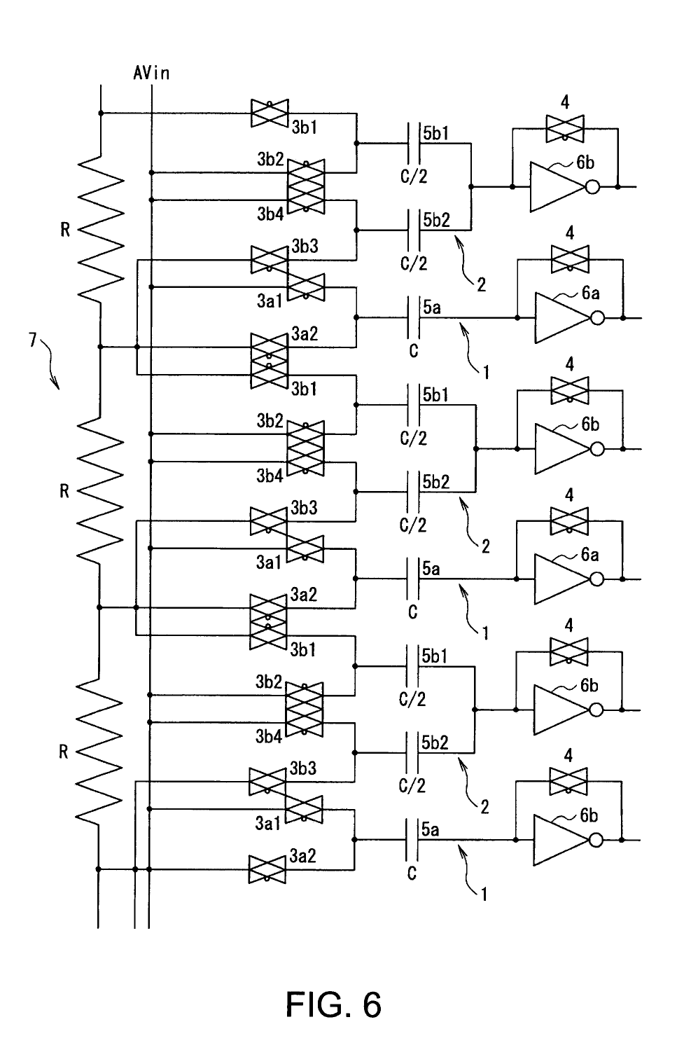

### DESCRIPTION OF EXEMPLARY EMBODIMENTS

Before explaining exemplary embodiments of the invention, the basic concept of the invention is explained below.

In a reference voltage generation circuit configured of a resistor array having a plurality of resistors connected in series and a plurality of analogue switches each being connected to a point between the resistors in the resistor array, the following problem is revealed to achieve the invention.

In a case where a transfer gate having two transistors in different types coupled in parallel is used as the analogue switch, the problem occurs that the circuit area and the amount of wires of the reference voltage generation circuit are increased.

To solve the problem, the use of only one of the two transistors in different types or a combination of both of the transistors as the analogue switch can be realized.

At that time, however, in a case where two input reference voltages (reference voltages to be input to a higher voltage side and a lower voltage side) to be supplied to both ends of the resistor array having the plurality of resistors connected in series, are near the upper or lower limit in an operational voltage range of the transistor, it is revealed that the reference voltage generation circuit hardly generates a desired reference voltage at a high speed.

Accordingly, attention is paid to some characteristics of the transistor to solve the problem, and the invention is achieved by utilizing the characteristics.

First embodiment of reference voltage generation circuit

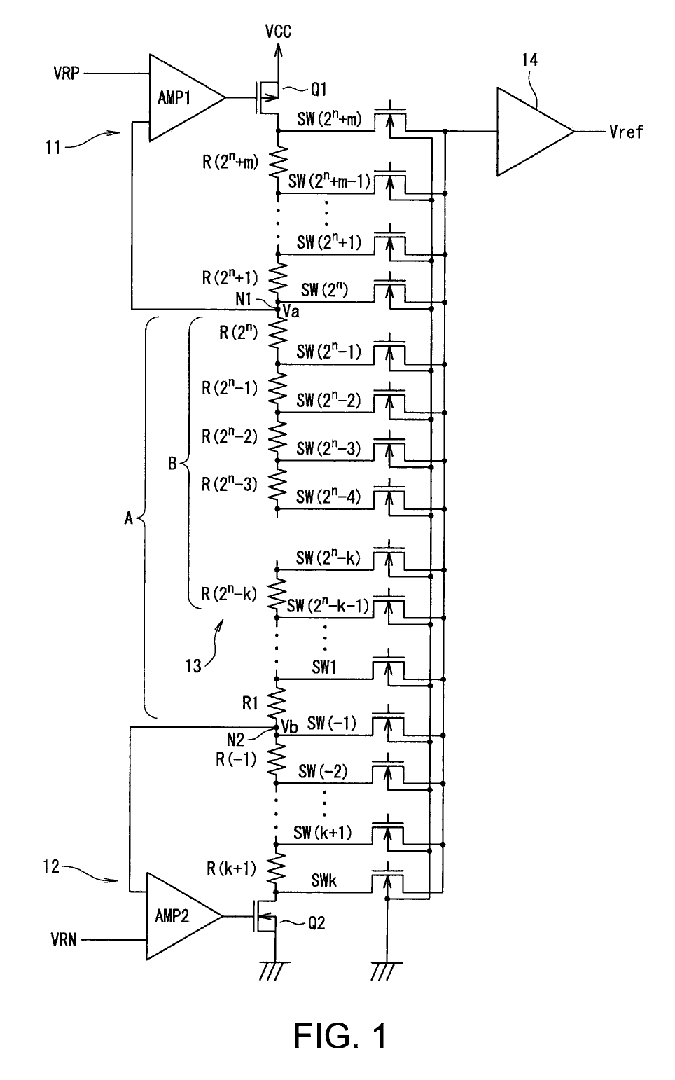

FIG. 1 is a circuit diagram showing a structure of a first embodiment of the reference voltage generation circuit of the invention.

An outline of the first embodiment of the reference voltage generation circuit is described below. An input reference voltage (for example, a voltage between a reference voltage Va at the higher side of a node N1 and a reference voltage Vb at the lower side of node N2) is divided into divisional voltages by a plurality of resistors connected in series, and one of the divisional voltages is selectively output as a reference voltage Vref by a plurality of analogue switches.

Accordingly, the first embodiment includes a first reference voltage setting circuit 11, a second reference voltage setting circuit 12, a resistor array 13 formed of 2ⁿ resistors R1 to R(2ⁿ), and (2ⁿ−1) analogue switches SW1 to SW(2ⁿ−1), and a buffer circuit 14, as shown in FIG. 1. On the basis of an input reference voltage VRP, the first reference voltage setting circuit 11 generates the reference voltage Va equal to the input reference voltage VRP on the node N1. The first reference voltage setting circuit 11 is configured of an operational amplifier AMP1, a PMOS transistor Q1 and a plurality of resistors R(2ⁿ+1) to R(2ⁿ+m) connected in series.

In the operational amplifier AMP1, one of input terminals is applied with the input reference voltage VRP and the other input terminal is applied with the reference voltage Va of the node N1. The output of the operational amplifier AMP1 is input to a gate of the MOS transistor Q1. A power supply voltage VCC is applied to a source of the MOS transistor Q1. The resistors R(2ⁿ+1) to R(2ⁿ+m) are connected in series between the node N1 and a drain of the MOS transistor Q1.

On the basis of an input reference voltage VRN, the second reference voltage setting circuit 12 generates the reference voltage Vb equal to the input reference voltage VRN on the node N2. The second reference voltage setting circuit 12 is configured of an operational amplifier AMP2, an NMOS transistor Q2, and a plurality of resistors R(−1) to R(k+1) connected in series. In the operational amplifier AMP2, one of input terminals is applied with the input reference voltage VRN and the other input terminal is applied with the reference voltage Vb of the node N2. The output of the operational amplifier AMP2 is input to a gate of the MOS transistor Q2. A source of the MOS transistor Q2 is grounded. The resistors R(−1) to R(k+1) are connected in series between the node N2 and a drain of the MOS transistor Q2.

The resistors R1 to R(2ⁿ) forming the resistor array (resistor ladder) 13 are connected in series between the node N1 and the node N2, and divide the voltage (Va-Vb) between the reference voltage Va of the node N1 and the reference voltage Vb of the node N2. The analogue switches SW1 to SW(2ⁿ−1) are formed of the NMOS transistors as shown in FIG. 1, one ends of analogue switches are respectively connected to connection points of the resistors R1 to R(2ⁿ) forming the resistor array 13, and the other ends thereof are commonly connected to the input side of the buffer circuit 14. One of the analogue switches SW1 to SW(2ⁿ−1) is turned on to output a desired divisional voltage as the reference voltage Vref.

Here, in all of or a part of the NMOS transistors forming the analogue switches SW1 to SW(2ⁿ−1), the sizes of the transistors are varied corresponding to the levels of the reference voltages Vref to be output, respectively as described later. When one of the analogue switches SW1 to SW(2ⁿ−1) is turned on, the buffer circuit 14 receives the divisional voltage corresponding thereto to output the received divisional voltage as the reference voltage Vref.

In the first embodiment, analogue switches SW(2ⁿ) to SW(2ⁿ+m) formed of the NMOS transistors are connected to connection points of the plurality of resistors R(2ⁿ+1) to R(2ⁿ+m) forming the first reference voltage setting circuit 11. Therefore, by turning on one of the analogue switches SW(2ⁿ) to SW(2ⁿ+m) on an as-needed basis, a desired voltage can be output via the buffer circuit 14 as the reference voltage Vref.

Likewise, analogue switches SW(−1) to SW(k) formed of the NMOS transistors are connected to connection points of the plurality of resistors R(−1) to R(k+1) forming the second reference voltage setting circuit 12. Accordingly, by turning on one of the analogue switches SW(−1) to SW(k) on an as-needed basis, a desired voltage can be output via the buffer circuit 14 as the reference voltage Vref.

Here, in a case where the analogue switches SW(2ⁿ) to SW(2ⁿ+m) and the analogue switches SW(−1) to SW(k) are formed of the MOS transistors, it is preferable to respectively very the sizes of the transistors corresponding to the levels of the reference voltages Vref. It is possible to omit the analogue switches SW(2ⁿ) to SW(2ⁿ+m) and the analogue switches SW(−1) to SW(k), on an as-needed basis or if not necessary.

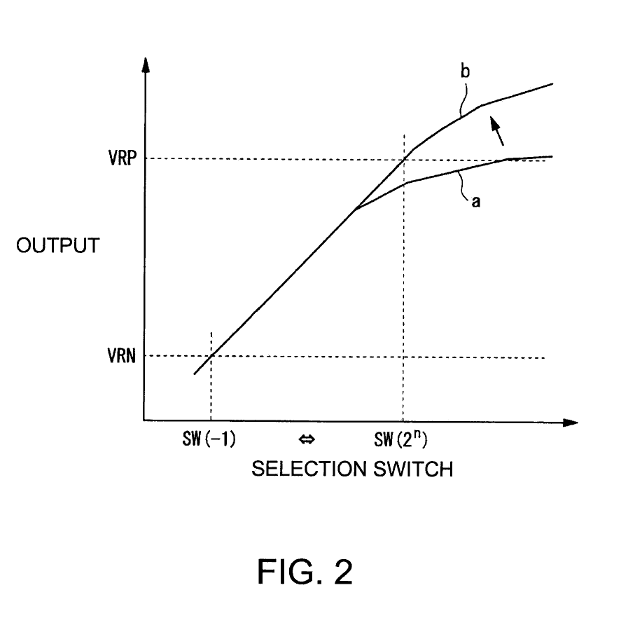

Next, exemplary operations of the first embodiment having the structure described above are explained with reference to FIG. 1 and FIG. 2. On the basis of the input reference voltage VRP, the first reference voltage setting circuit 11 generates the reference voltage Va equal to the input reference voltage VRP on the node N1. By arbitrarily setting the input reference voltage VRP, an arbitrary value can be obtained as the reference voltage Va.

Likewise, on the basis of the input reference voltage VRN, the second reference voltage setting circuit 12 generates the reference voltage Vb equal to the input reference voltage VRN on the node N2. By arbitrarily setting the input reference voltage VRN, an arbitrary value can be obtained as the reference voltage Vb. The voltage (Va-Vb) between the reference voltage Va of the node N1 and the reference voltage Vb of the node N2 is divided into divisional voltages by the resistors R1 to R(2ⁿ) in the resistor array 13 disposed in a region A in FIG. 1. A desired voltage in the divisional voltages is output as the reference voltage Vref by turning on one of the analogue switches SW1 to SW(2ⁿ−1).

That is, it is possible to select a desired divisional voltage as the reference voltage by applying a control signal to a gate of the NMOS transistor in the analogue switches SW1 to SW(2ⁿ−1) to turn on a desired MOS transistor by means of the control signal. The selected desired reference voltage is buffered by the buffer circuit 14 to be output as the reference voltage Vref. The operation speed at which the reference voltage selected by the analogue switches SW1 to SW(2ⁿ−1) is output, is determined by the resistance value of the resistor array 13, an on-resistance of each of the analogue switches SW1 to SW(2ⁿ−1) and a capacitance of the input terminal (a common terminal of the analogue switches) of the buffer circuit 14.

In a case where the NMOS transistors each having the small size of W/L (W: the width of the gate, L: the length of the gate) are used as the components forming the analogue switches SW1 to SW(2ⁿ−1), a low reference voltage VRN can be selected to be output. However, in a case where the selected, output reference voltage is raised stepwise, for example, to be near the reference voltage VRP, when the NMOS transistors having the same sizes of W/L are used, it is difficult to readily output the reference voltage at a desired operation speed (see curve “a” in FIG. 2).

In order to solve the above problem to retain the operation as curve “b” in FIG. 2, the sizes of W/L (the sizes of the transistors) of the analogue switches SW(2ⁿ−k−1), SW(2ⁿ−k), and SW(2ⁿ−4) to SW(2ⁿ−1) formed of the NMOS transistors connected to the resistors R(2ⁿ−K), and R(2ⁿ−3) to R(2ⁿ) in the resistor array 13 disposed in a region B in FIG. 1 are made greater stepwise.

Accordingly, it is possible to increase the operation speed which has been restricted by the resistance of the resistor array 13, the on-resistance of the analogue switch, and the capacitance of the input terminal of the buffer circuit 14.

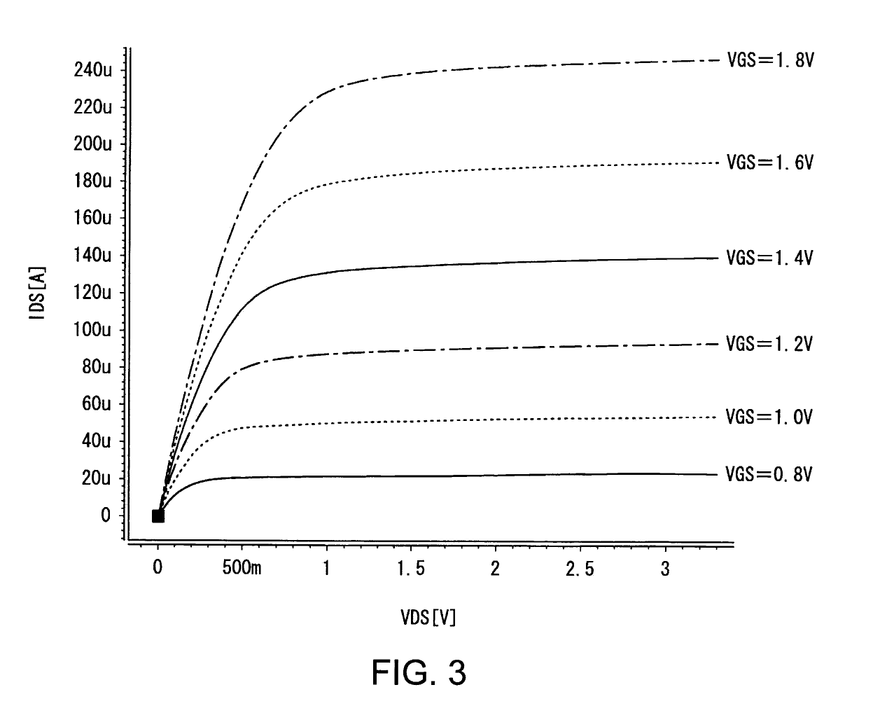

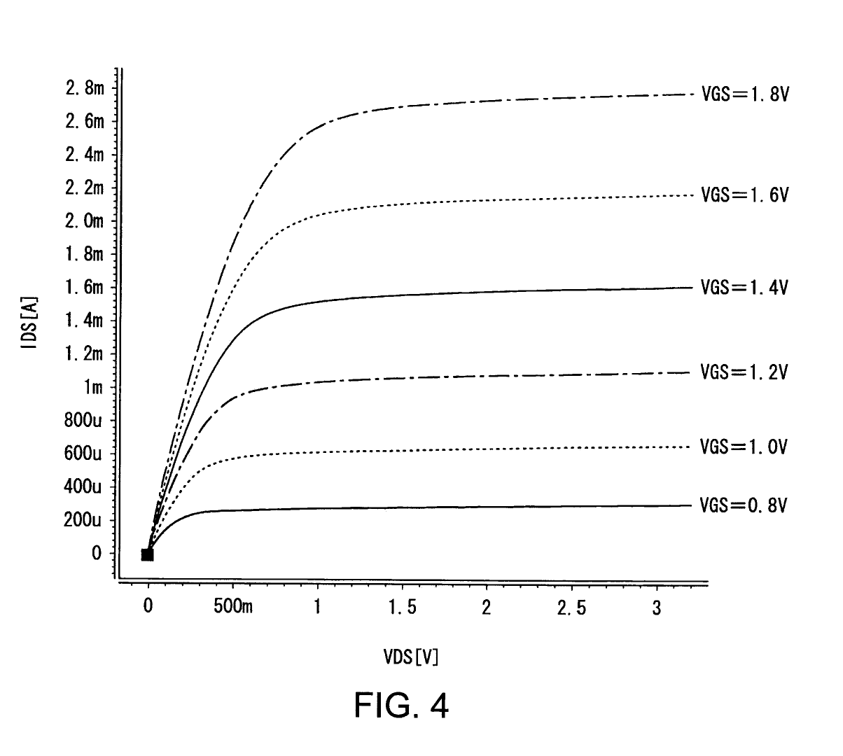

Next, the reason why the analogue switches are formed as in the above described embodiment, will be explained with reference to FIG. 3 and FIG. 4. When the size of the NMOS transistor is set so as to be adaptable to the selection of the highest reference voltage, the NMOS transistor having the large size is to be used. In this case, the NMOS transistors with the large sizes should be used for the analogue switches from the analogue switch SW1 for selecting the lowest reference voltage to the analogue switch SW(2ⁿ−1) for selecting the highest reference voltage so that the area occupied by them becomes comparatively large.

Here, the NMOS transistor has static characteristics shown by FIG. 3 and FIG. 4. In FIG. 4, the length L of the gate is the same as that in FIG. 3, and the width W of the gate is 10 times of that in FIG. 3. In FIG. 3 and FIG. 4, the horizontal axis indicates a voltage VDS between the drain and source, and the vertical axis indicates a drain current IDS flowing between the drain and source. A voltage VGS is applied between the gate and source, and is increased stepwise by 0.2 V.

Based on the FIG. 3 and FIG. 4, as the drain current IDS can be increased in proportion to the width W of the gate (for example, in the case of VGS=0.8 V, IDS=20 μA in FIG. 3, IDS=200 μA in FIG. 4), the resistance value at the on-state of the analogue switch formed of the NMOS transistor can be lowered. Consequently, the sizes of the gate widths W of the MOS transistors are varied stepwise according to the characteristics.

Accordingly, it is possible to achieve designing capable of preventing the operation speed in the event of outputting the reference voltage from being lowered while minimizing the occupied area of the array of the analogue switches.

Here, taking into consideration the ease of layout, it is not necessary to precisely vary the sizes of the NMOS transistors. A group of the selected, output reference voltages is divided into a plurality of blocks, and then the number of sizes of the NMOS transistors can be made two or more to be prepared by being matched with the number of blocks.

Thus, according to the first embodiment of the reference voltage generation circuit, it is possible to minimize the occupied area of the plurality of analogue switches while retaining the operation speed at which the plurality of analogue switches output the desired reference voltages.

### Modified Example of First Embodiment

The modified example is so constituted that the NMOS transistors forming the analogue switches of the first embodiment in FIG. 1 are replaced with the PMOS transistors. In the case of the PMOS transistors, the sizes (W/L) of the transistors are increased stepwise from the analogue switch for selecting the highest reference voltage to the analogue switch for selecting the lowest reference voltage.

Accordingly, in a case where the sizes are varied stepwise, the size of the analogue switch for selecting the highest reference voltage is made minimum, and the size of the analogue switch for selecting the lowest reference voltage is made maximum.

By satisfying the above concept, the sizes of the transistors can be determined as in the case of the NMOS transistors. By using the modified example in the above described structure, it is possible to achieve the active effect the same as that of the first embodiment.

### Second Embodiment of Reference Voltage Generation Circuit

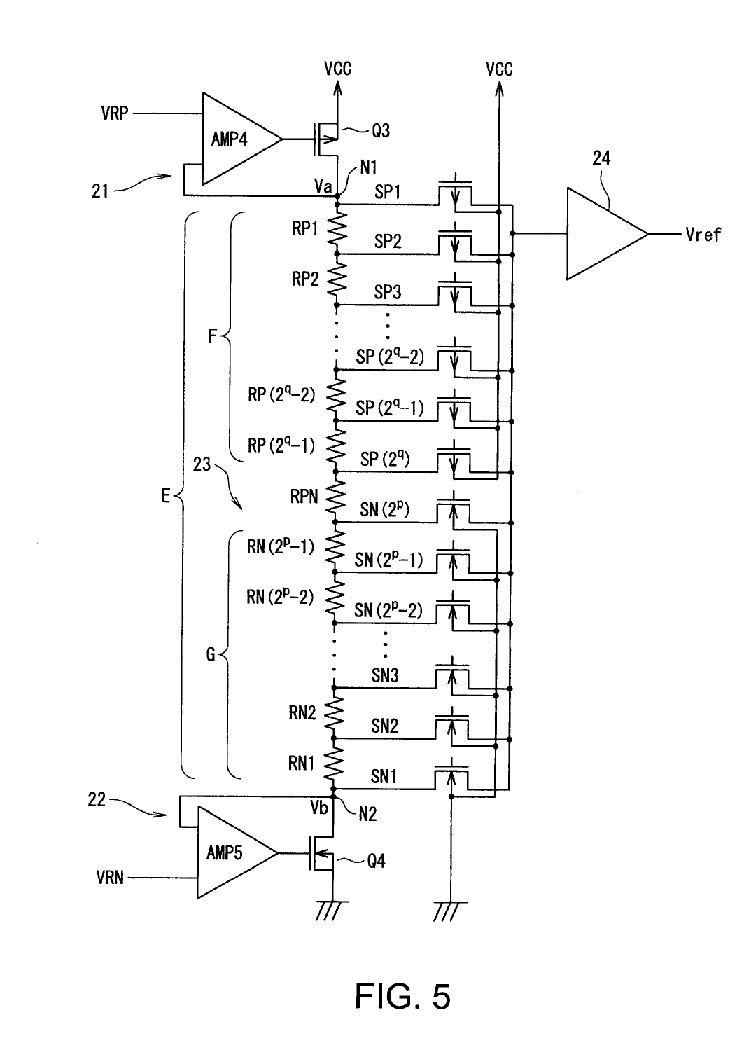

FIG. 5 is a circuit diagram showing a structure of a second embodiment of a reference voltage generation circuit of the invention. An outline of the second embodiment of the reference voltage generation circuit is explained below. An input reference voltage (for example, a voltage between a reference voltage Va at the higher side of a node N1 and a reference voltage Vb at the lower side of node N2) is divided into a plurality of divisional voltages by a plurality of resistors connected in series, one of the divisional voltages is selectively output as the reference voltage Vref by a plurality of analogue switches.

Accordingly, the second embodiment includes a first reference voltage setting circuit 21, a second reference voltage setting circuit 22, a resistor array 23 configured of a plurality of resistors RP1 to RP(2^{q}−1), RPN, and RN1 to RN(2p−1), analogue switches SP1 to SP(2q),and SN1 to SN(2p), and a buffer circuit 24, as shown in FIG. 5.

On the basis of the input reference voltage VRP in an arbitrary level, the first reference voltage setting circuit 21 generates the reference voltage Va equal to the input reference voltage VRP on the node N1. The first reference voltage setting circuit 21 is configured of an operational amplifier AMP4 and a MOS transistor Q3.

In the operational amplifier AMP4, one of the input terminals is applied with the input reference voltage VRP and the other input terminal is applied with the reference voltage Va of the node N1. The output of the operational amplifier AMP4 is input to the gate of the MOS transistor Q3. The power supply voltage VCC is applied to the source of the MOS transistor Q3. The drain of the MOS transistor Q3 is connected to the resistor RP1.

On the basis of the input reference voltage VRN, the second reference voltage setting circuit 22 generates the reference voltage Vb equal to the input reference voltage VRN on the node N2. The second reference voltage setting circuit 22 is configured of an operational amplifier AMPS and an NMOS transistor Q4. In the operational amplifier AMPS, one of the input terminals is applied with the input reference voltage VRN and the other input terminal is applied with the reference voltage Vb of the node N2. An output of the operational amplifier AMPS is input to the gate of the MOS transistor Q4. A source of the MOS transistor Q4 is grounded. A drain of the MOS transistor Q4 is connected to the resistor RN1.

The resistors RP1 to RP(2^{q}−1), RPN, and RN1 to RN(2^{q}−1) forming the resistor array 23 are connected in series between the node N1 and the node N2, and divide the voltage (Va-Vb) between the reference voltage Va of the node N1 and the reference voltage Vb of the node N2.

The analogue switches SP1 to SP(2^{q}) are formed of the PMOS transistors as shown in FIG. 5, one ends of analogue switches are respectively connected to the resistors RP1 to RP(2^{q}−1) and RPN forming the resistor array 23, and the other ends thereof are commonly connected to the input side of the buffer circuit 24. One of the analogue switches SP1 to SP(2^{q}) is turned on to output a desired divisional voltage as the reference voltage Vref.

The analogue switches SN1 to SN(2^{p}) are configured of the NMOS transistors as shown in FIG. 5, one ends of analogue switches are respectively connected to the resistors RN1 to RN(2^{p}−1), and RPN forming the resistor array 23, and the other ends thereof are commonly connected to the input side of the buffer circuit 24. One of the analogue switches SN1 to SN(2^{p}) is turned on to output a desired divisional voltage as the reference voltage Vref.

Here, in the PMOS transistors forming the analogue switches SP1 to SP(2^{q}), the sizes of the transistors are varied corresponding to the levels of the reference voltages Vref to be output, respectively as described later. In addition, in the NMOS transistors forming the analogue switches SN1 to SN(2^{p}), the sizes of the transistors are varied corresponding to the levels of the reference voltages Vref to be output, respectively as described later. When one of the analogue switches SP1 to SP(2^{q}), and SN1 to SN(2^{p}) is turned on, the buffer circuit 24 receives the divisional voltage in response thereto and outputs the received divisional voltage as the reference voltage Vref.

Next, an exemplary operation of the second embodiment having the structure described above is explained with reference to FIG. 5. On the basis of the input reference voltage VRP, the first reference voltage setting circuit 21 generates the reference voltage Va equal to the input reference voltage VRP on the node N1. By arbitrarily setting the input reference voltage VRP, an arbitrary value can be obtained as the reference voltage Va.

Likewise, on the basis of the input reference voltage VRN, the second reference voltage setting circuit 22 generates the reference voltage Vb equal to the input reference voltage VRN on the node N2. By arbitrarily setting the input reference voltage VRN, an arbitrary value can be obtained as the reference voltage Vb.

The voltage (Va-Vb) between the reference voltage Va of the node N1 and the reference voltage Vb of the node N2 is divided into divisional voltages by the resistors RP1 to RP(2^{q}−1), RPN, and PN1 to PN(2^{p}−1) in the resistor array 23 disposed in a region E in FIG. 5. A desired voltage in the divisional voltages is output as the reference voltage Vref by turning on one of the analogue switches SP1 to SP(2^{q}), and SN1 to SN(2^{p}).

That is, when one of the divisional voltages of the resistors RP1 to RP(2^{q}−1) disposed in a region F in FIG. 5 is selected, a control signal is applied to one gate of the PMOS transistors forming the analogue switches SP1 to SP(2^{q}) to turn on the desired MOS transistor by means of the control signal, thereby, it is possible to select a desired divisional voltage as the reference voltage. The selected desired reference voltage is buffered by the buffer circuit 24 to be output as the reference voltage Vref.

On the other hand, when one divisional voltage of the resistors RN1 to RN(2^{p}−1) disposed in a region G in FIG. 5 is selected, a control signal is applied to one gate of the NMOS transistors forming the analogue switches SN1 to SN(2^{p}) to turn on a desired MOS transistor, thereby, it is possible to select a desired divisional voltage as the reference voltage. The selected desired reference voltage is buffered by the buffer circuit 24 to be output as the reference voltage Vref.

The operation speed in the event of outputting the reference voltage selected by the analogue switches SP1 to SP(2^{q}) and SN1 to SN(2^{p}) is roughly determined by the resistance value of the resistor array 23, an on-resistance of each of the analogue switches and a capacitance of the input terminal (a common terminal of the analogue switches) of the buffer circuit 24.

Here, if the NMOS transistors having small sizes of W/L are used as the analogue switches SP1 to SP(2^{q}) and SN1 to SN(2^{p}), a low reference voltage can be selected to be output as described in the first embodiment. However, in a case where the selected, output reference voltage is raised stepwise, it is difficult to readily output the reference voltage at a desired operation speed even when the NMOS transistors having the same sizes of W/L are used (see curve “a” in FIG. 2).

Likewise, if the PMOS transistors each having the small size of W/L are used as the components of the analogue switches SP1 to SP(2^{q}), and SN1 to SN(2^{p}), a high reference voltage can be selected to be output. However, in a case where the selected, output reference voltage is lowered stepwise, even when the PMOS transistors having the same sizes of W/L are connected, it is difficult to readily output the reference voltage at a desired operation speed.

Here, in the second embodiment, the NMOS transistors are used as the analogue switches SN1 to SN(2^{p}) to be connected to the resistors RN1 to RN(2^{p}−1) forming the resistor array 23 in the region G in FIG. 5. On the other hand, the PMOS transistors are used as the analogue switches SP1 to SP(2^{q}) to be connected to the resistors RP1 to RP(2^{q}−1) forming the resistor array 23 in the region F in FIG. 5.

Next, specific concepts and structures of the analogue switches SP1 to SP(2^{q}) and SN1 to SN(2^{p}) are described in detail below. In a case where the size of the NMOS transistor forming the analogue switch is set such that the highest reference voltage can be selected, the NMOS transistor having the large size should be used. At that time, the analogue switches from one for selecting the lowest reference voltage to one for selecting the highest voltage are to be formed of the NMOS transistors having the large sizes, resulting in significantly increase of the area occupied thereby.

In addition, in a case where the reference voltage VRP (Va) is set to be so high that a threshold voltage of the NMOS transistor is not attained, even when the NMOS transistor having the large size of W/L is used, the NMOS transistor could not turn on, and then a desired reference voltage is not obtained. Accordingly, in the second embodiment, the NMOS transistors are used as the analogue switches SN1 to SN(2^{p}) in the region G in which the desired reference voltages are low, and PMOS transistors are used as the analogue switches SP1 to SP(2^{q}) in the region F in which the desired reference voltages are high, the PMOS transistors being sufficiently operable in the range of the above reference voltages.

The NMOS transistor has static characteristics as shown in FIG. 3 and FIG. 4. Based on the FIG. 3 and FIG. 4, as the drain current IDS can be increased in proportion to size of the gate width W of the NMOS transistor, the resistance value at the on-state of the analogue switch formed of the NMOS transistor can be lowered. Likewise, the drain current can be increased in proportion to the gate width of the PMOS transistor, and then the resistance value at the on-state of the analogue switch formed of the PMOS transistor can be lowered.

Here, the sizes of the gate widths W of the NMOS transistors forming the analogue switches SN1, SN2, SN3 to SN(2^{p}−2), SN(2^{p}−1) and SN(2^{p}) are increased stepwise in the region G of the low desired reference voltages. Likewise, the sizes of the gate widths W of the PMOS transistors forming the analogue switches SP1, SP2, SP3 to SP(2^{q}−2), SP(2^{q}−1) and SP(2^{q}) are increased stepwise in the region F of the high desired reference voltages.

Accordingly, it is possible to prevent the operation speed in the event of outputting the reference voltage from being lowered while minimizing the occupied area of the array of the analogue switches. Here, taking into consideration the ease of layout, it is not necessary to precisely vary the sizes of the NMOS transistors and the PMOS transistors. A group of the selected, output reference voltages is divided into a plurality of blocks, and then the number of sizes of the NMOS transistors or the PMOS transistors can be made two or more to be prepared by being matched with the number of blocks.

The sizes of W/L of the NMOS transistors SN1, SN2, SN3 to SN(2^{p}−2), SN(2^{p}−1) and SN(2^{p}) in the region G of the lower reference voltages can be designed to be in one kind, likewise, the sizes of W/L of PMOS transistors SP1, SP2, SP3 to SP(2^{q}−2), SP(2^{q}−1) and SP(2^{q}) in the region F of the higher reference voltages can be formed to be in one kind.

Thus, according to the second embodiment of the reference voltage generation circuit, it is possible to minimize the occupied area of the plurality of analogue switches while retaining the operation speed at which the plurality of analogue switches output the desired reference voltages.

### Embodiment of AD Converter

Next, an embodiment of an AD converter of the invention is described below. The embodiment of the AD converter is one application in the first embodiment (including a modified example) and the second embodiment of the reference voltage generation circuit. The embodiment of the AD converter is so constituted that a reference voltage obtained from one of the above first and second embodiments is used for the reference voltage of a comparator in the event of AD converting.

According to the embodiment of the AD converter in the above structure, the operation speed in the event of outputting the reference voltage from the reference voltage generation circuit is comparatively high, resulting in achievement of the comparatively high speed AD converting.

### Embodiment of DA Converter

Next, an embodiment of a DA converter of the invention is described below. The embodiment of the DA converter is one application in the first embodiment (including a modified example) and the second embodiment of the reference voltage generation circuit. The embodiment of the DA converter is so constituted that a reference voltage obtained from one of the above first and second embodiments is used for the reference voltage of a comparator in the event of DA converting.

According to the embodiment of the DA converter in the above structure, the operation speed in the event of outputting the reference voltage from the reference voltage generation circuit is comparatively high, resulting in achievement of the comparatively high speed AD converting.

### Embodiment of Image Processor

Next, an embodiment of an image processor of the invention is described below. The embodiment of the image processor is an application of the embodiment of AD converter or the DA converter. In the embodiment, at least one of the AD converter and DA converter is utilized in the image processor configured of a computer and the like.

According to the embodiment of the image processor in the above structure, by using the above AD converter or DA converter, comparatively high speed AD converting or DA converting can be performed, thereby increasing the speed of processing an image.

Others

In the embodiment of the reference voltage generation circuit, a single N-type or P-type transistor is used as the analogue switch. A transfer gate which is a combination of N-type and P-channel MOS transistors can be used as the analogue switch.

The present invention is not limited to the above illustrative embodiments, and various modifications can be made within the scope of the invention.

What is claim is:

1. A reference voltage generation circuit comprising:
a plurality of resistors that divide a prescribed input reference voltage into a plurality of divisional voltages; and
a plurality of analogue switches one of which selects one of the divisional voltages to output the selected divisional voltage as a desired reference voltage,
wherein each of the analogue switches is formed of a transistor, and a size of the transistor is varied corresponding to a level of reference voltage to be output.

2. A reference voltage generation circuit comprising:
a plurality of resistors that divide a prescribed input reference voltage into a plurality of divisional voltages; and
a plurality of analogue switches one of which selects one of the divisional voltages to output the selected divisional voltage as a desired reference voltage,
wherein each of the analogue switches is formed of a transistor, each size of each of a prescribed number of transistors is made to be a prescribed value, and sizes of remaining transistors are varied corresponding to levels of the reference voltages to be output, respectively.

3. The reference voltage generation circuit according to claim 1,
wherein each of the analogue switches is configured of one of an N-channel MOS transistor, a P-channel MOS transistor, and a transfer gate having a combination of N-type and P-type transistors.

4. A reference voltage generation circuit comprising:
a plurality of resistors that divide a prescribed input reference voltage into a plurality of divisional voltages; and
a plurality of analogue switches one of which selects one of the divisional voltages to output the selected divisional voltage as a desired reference voltage,
wherein the analogue switches are formed of a prescribed number of N-channel MOS transistors and a prescribed number of P-channel MOS transistors, and sizes of the prescribed number of N-type and P-type transistors are varied corresponding to levels of the reference voltage to be output, respectively.

5. An AD converter comprising:
the reference voltage generation circuit according to claim 1,
wherein the AD converter performs AD converting by using a desired reference voltage output from the reference voltage generation circuit.

6. A DA converter comprising:
the reference voltage generation circuit according to claim 1,
wherein the DA converter performs DA converting by using a desired reference voltage output from the reference voltage generation circuit.

7. An image processor comprising:
at least one of the AD converter according to claim 5 and the DA converter according to claim 6.
